(19) United States
(12) Patent Application Publication
(10) Pub. No.: US 2026/0032569 A1
(43) Pub. Date: Jan. 29, 2026

(54) SYSTEMS AND METHODS FOR IMPLEMENTING SERVICE AWARE INTEGRATED TERRESTRIAL NETWORKS AND NON-TERRESTRIAL NETWORK SYSTEMS

(71) Applicant: AT&T Intellectual Property I, L.P., Atlanta, GA (US)

(72) Inventors: Zhi Cui, Sugar Hill, GA (US); Hongyan Lei, Plano, TX (US); Ye Chen, Marietta, GA (US)

(73) Assignee: AT&T Intellectual Property I, L.P., Atlanta, GA (US)

(21) Appl. No.: 18/782,177

(22) Filed: Jul. 24, 2024

(51) Int. Cl. H04W 48/18; H04W 84/06

(52) U.S. Cl. CPC H04W 48/18; H04W 84/06

(57) ABSTRACT

Aspects of the subject disclosure may include, for example, connecting a user equipment (UE) to integrated networks including one or more terrestrial networks and one or more non-terrestrial networks, running a non-real time radio access network intelligent controller (non-RT RIC) at a service management and orchestration platform (SMO) of the O-RAN by running a plurality of rApps to manage traffic from the one or more terrestrial networks and the one or more non-terrestrial networks, and running a near-real time radio access network intelligent controller (near-RT RIC), where the running the near-RT RIC further comprises running an xApp to receive a UE measurement report and manage an automatic neighbor relation table in response to a command from one or more of the plurality of rApps. Other embodiments are disclosed.

### FIELD OF THE DISCLOSURE

The subject disclosure relates to systems and methods for implementing service aware integrated terrestrial networks and non-terrestrial networks systems.

### BACKGROUND

Currently, terrestrial networks and non-terrestrial networks (NTN) tend to be siloed and separately managed. Non-terrestrial networks (NTN) are wireless communication systems that operate above the ground, such as satellites, unmanned aerial vehicles, high-altitude platforms (HAPS) and drones. NTN can be used for cellular network backup. It is desirable to integrate terrestrial networks and NTN or achieve a certain level of collaboration.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative operation of an integrated terrestrial and non-terrestrial network system in accordance with various aspects described herein.

FIG. 2C depicts an example, non-limiting embodiment of an automatic neighbor relation table in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 2F depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods for implementing service aware integrated terrestrial networks (TN) and non-terrestrial networks (NTN). The systems and methods implement the service aware integrated TN and TNT using an open radio access network (O-RAN) platform where one or more rApps are configured to collaborate with an xApp and another O-RAN platform in order to integrate TN and TNT. Other embodiments are described in the subject disclosure.

One or more aspects of the subject disclosure are directed to a device including a processing system of an open radio access network (O-RAN) including a processor, and a memory that stores executable instructions that, when executed by the processing system, facilitate performance of operations. The operations include communicating with integrated networks including one or more terrestrial networks and one or more non-terrestrial networks, wherein user equipment (UE) are connected to the integrated networks for communication; running a non-real time radio access network intelligent controller (non-RT RIC) at a service management and orchestration platform (SMO); running a near-real time radio access network intelligent controller (near-RT RIC), wherein the near-RT RIC is in communication with the non-RT RIC; receiving network conditions and UE measurements across the integrated networks; subscribing services from service exposure for policies; and based on the received network conditions, the UE measurements, or both and based on the services subscription, selecting a network among the integrated networks.

One or more aspects of the subject disclosure are directed to a non-transitory machine-readable medium, comprising executable instructions that, when executed by a processing system of an open radio access network (O-RAN) including a processor, facilitate performance of operations. The operations include connecting a user equipment (UE) to integrated networks including one or more terrestrial networks and one or more non-terrestrial networks: running a non-real time radio access network intelligent controller (non-RT RIC) at a service management and orchestration platform (SMO) of the O-RAN by running a plurality of rApps to manage traffic from the one or more terrestrial networks and the one or more non-terrestrial networks; and running a near-real time radio access network intelligent controller (near-RT RIC), wherein the running the near-RT RIC further comprises running an xApp to receive a UE measurement report and manage an automatic neighbor relation table in response to a command from one or more of the plurality of rApps.

One or more aspects of the subject disclosure are directed to a method including connecting, by a processing system of an open radio access network (O-RAN) including a processor, a user equipment to integrated networks including one or more terrestrial networks and one or more non-terrestrial networks: receiving network conditions and UE measurements across the integrated networks; executing, by the processing system, a non-real time radio access network intelligent controller (non-RT RIC) at a service management and orchestration (SMO) platform of the O-RAN, wherein the executing the non-RT RIC comprises running a plurality of rApps configured to manage traffic from the one or more terrestrial networks and the one or more non-terrestrial networks; executing, by the processing system, a near-real time radio access network intelligent controller (near RT RIC), wherein executing the near RT RIC further comprises running an xApp configured to manage an automatic neighbor relation table in response to a command by one or more of the plurality of rApps; subscribing services from service exposure for policies; based on the received network conditions, the UE measurements, or both and based on the services subscription, selecting a network among the integrated networks or adding a new neighbor network; and configuring, by the processing system, the O-RAN with service aware integrated terrestrial and NTN traffic management.

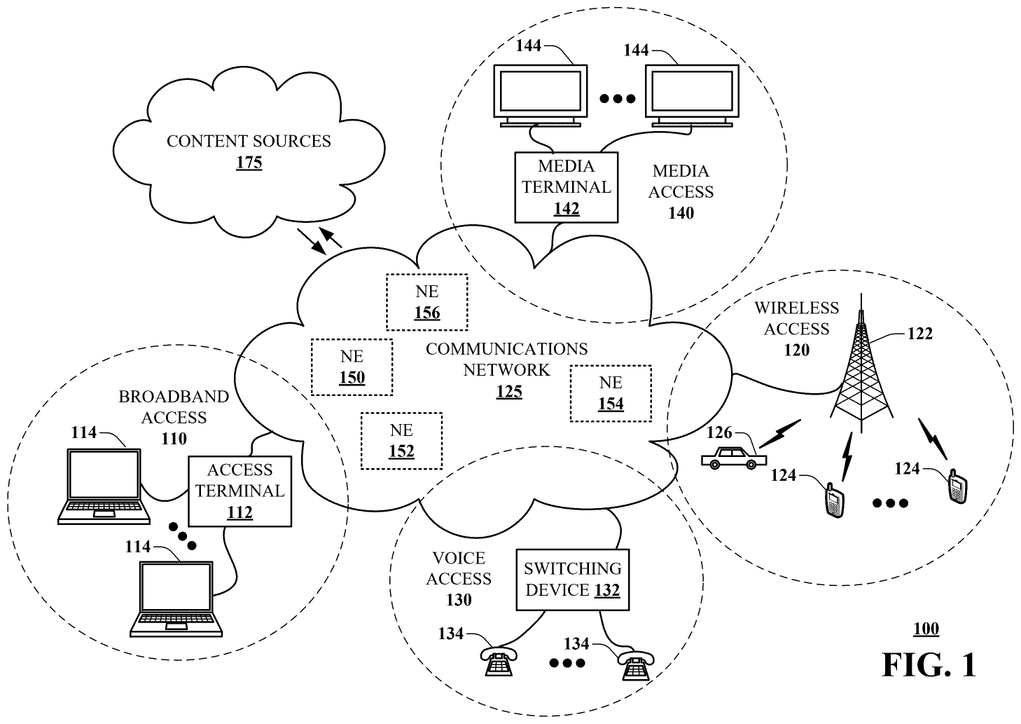

Referring now to FIG. 1, a block diagram is shown illustrating an example, non-limiting embodiment of a system 100 in accordance with various aspects described herein. For example, system 100 can facilitate in whole or in part systems and methods for implementing service aware integrated terrestrial networks and non-terrestrial networks systems. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

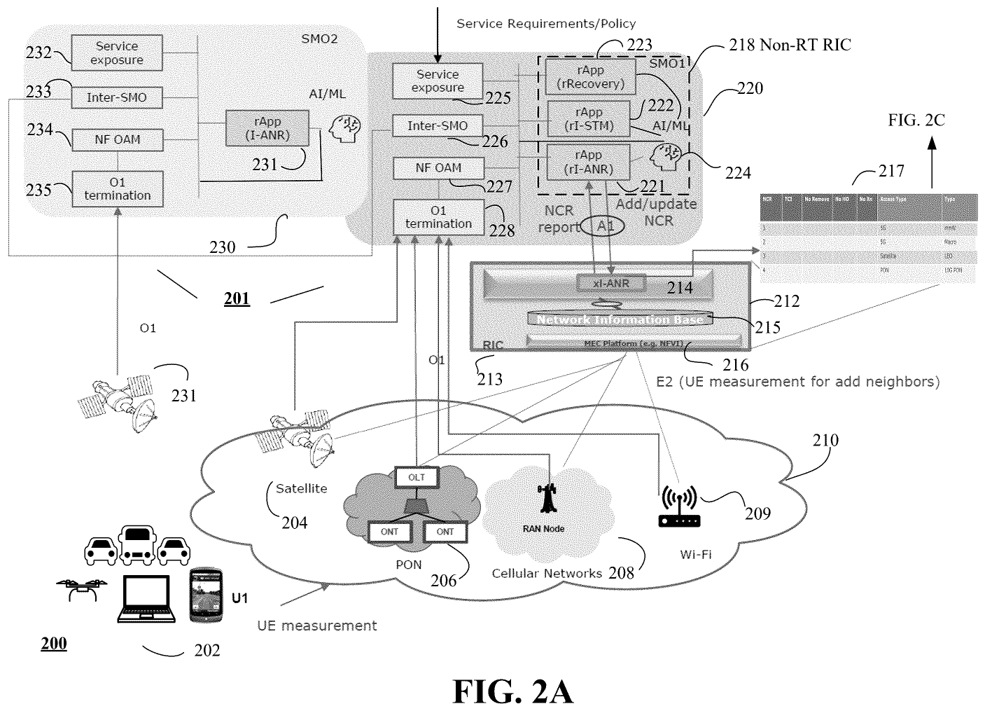

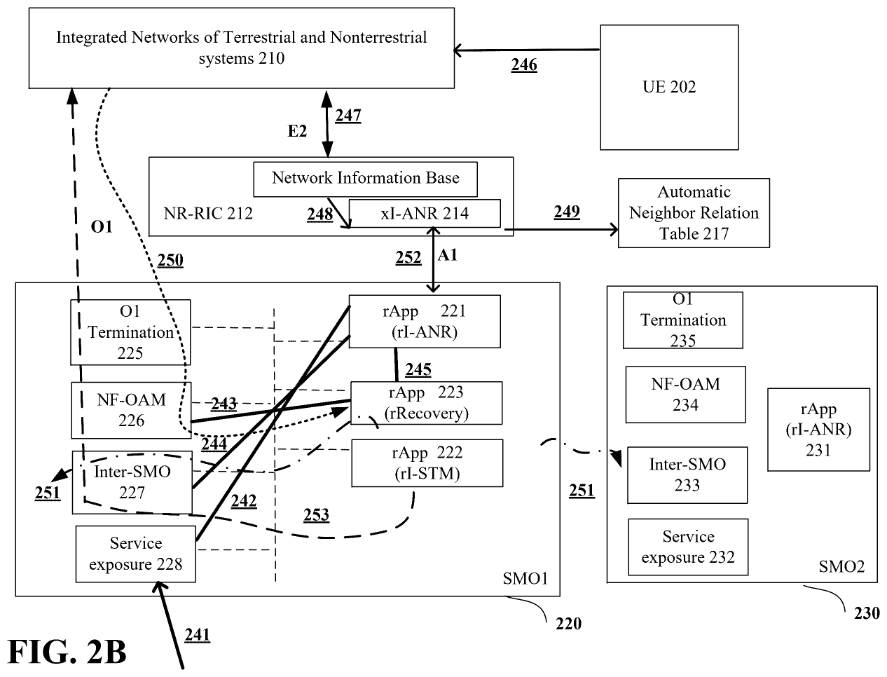

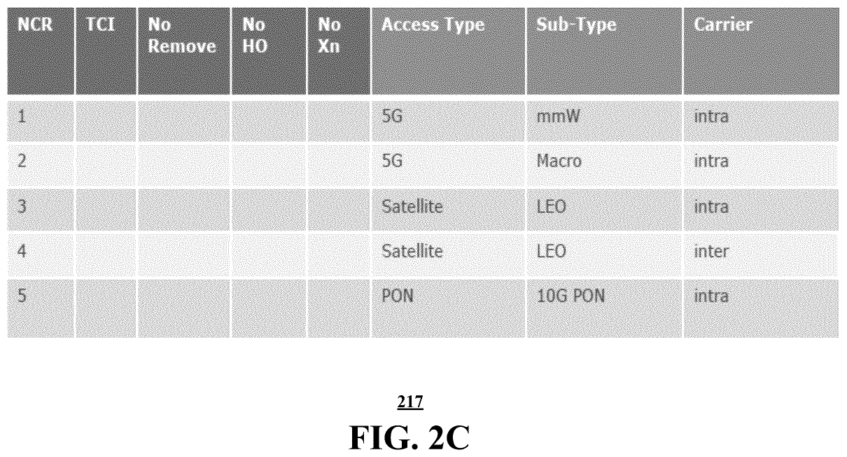

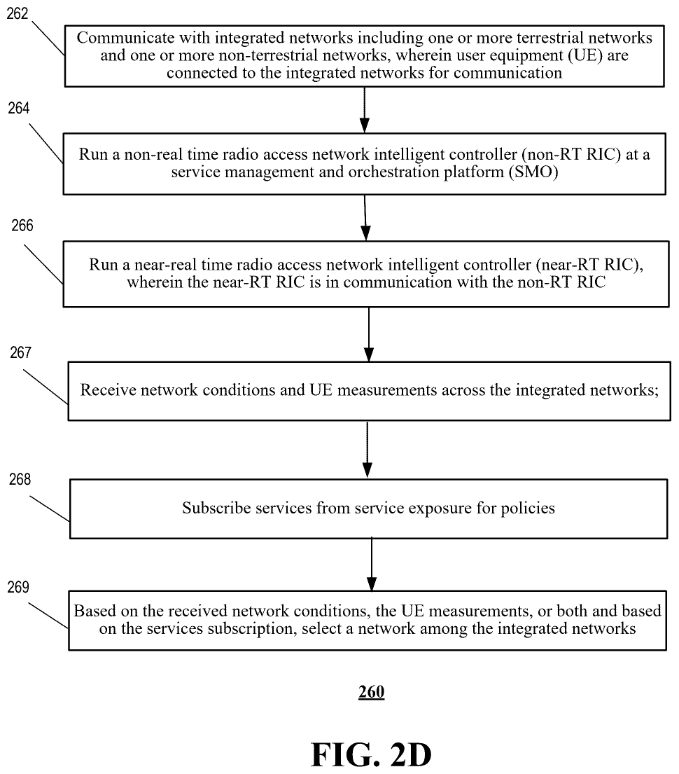

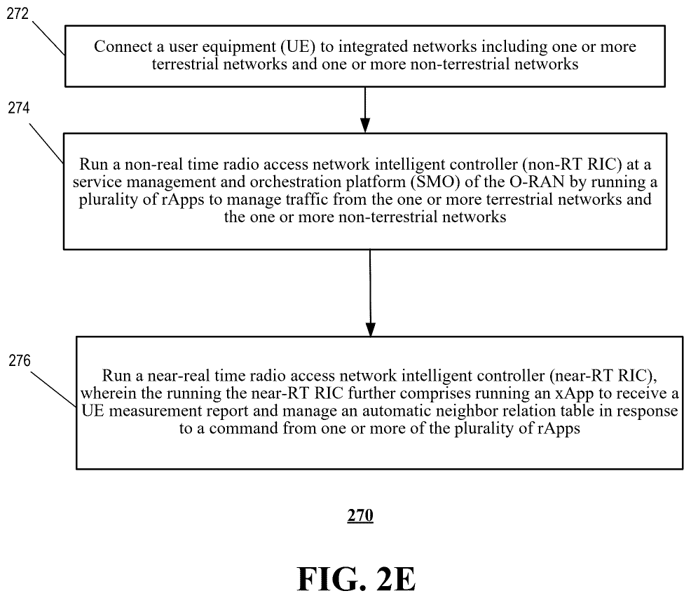

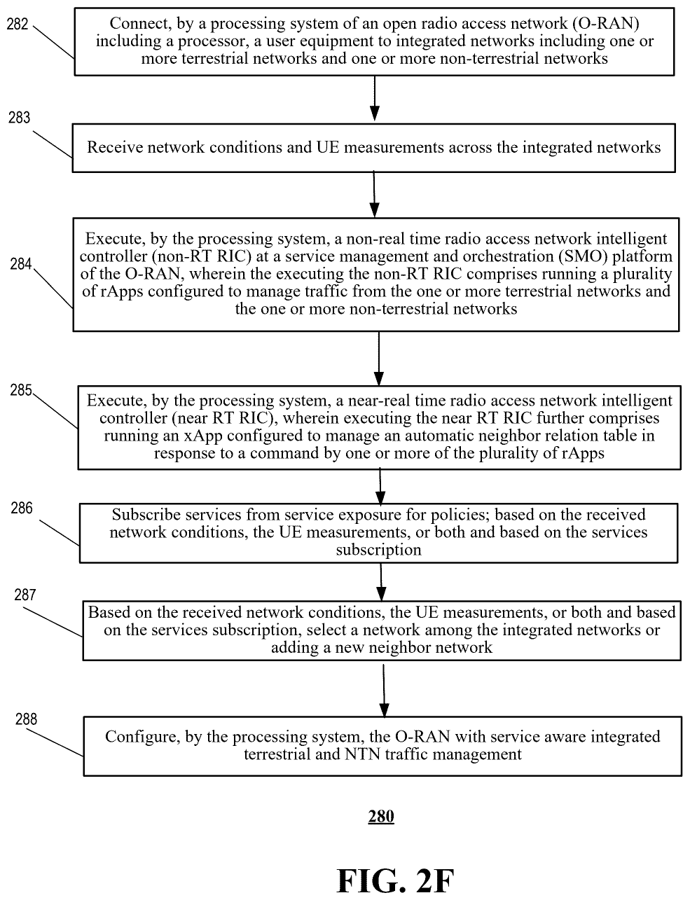

FIG. 2A is a block diagram illustrating an example, non-limiting embodiment of a system 200 functioning within the communication network of FIG. 1 in accordance with various aspects described herein. In various embodiments, the system 200 includes terrestrial networks and non-terrestrial networks (NTN) and serves as an integrated system of terrestrial networks and NTN. The system 200 includes user equipment 202, open-radio access networks (O-RAN) 201, and integrated networks 210 to which the user equipment 202 is connected via the O-RAN 201.

In various embodiments, examples of UEs 202 include mobile devices, display and television devices, home and business networks, IoT devices, video and audio devices, autonomous vehicles, unmanned aerial vehicles (UAVs), and so on. The UEs 202 may be equipped with one or more transmitter (Tx) devices and/or one or more receiver (Rx) devices configured to communicate with, and utilize network resources of, the system 200. Various types of UEs 202 may operate in battery constrained environments and/or situations. Energy savings and reducing power consumption can be an important part in operations of UEs 202.

UAVs may include any (e.g., manually controllable or autonomous) personal or commercial aerial vehicle or device that is equipped with one or more types of devices or components for performing various actions. In certain embodiments, UAVs may include one or more radio equipment configured to function as a cellular relay (e.g., low-powered cellular radio access (or small cell) node(s)), one or more sensors (e.g., image sensor(s), infrared sensor(s), near infrared camera(s), radar system(s), light detection and ranging (LIDAR) system(s), biological sensor(s), temperature sensor(s), chemical sensor(s), humidity sensor(s), and/or the like) for capturing information/data in an environment of UAVs, one or more mechanical limbs for physically manipulating external objects, and/or the like. In some embodiments, one or more UAVs may be deployed to provide network connectivity for other UE(s). In certain embodiments, UAVs may provide network connectivity by way of wireless “tethering” to (e.g., a base station or the like of) an access network like the access network 204 or a different access network (i.e., one that is not experiencing a traffic surge condition) and/or via a wired link (e.g., over a fiber connection) to a network device (e.g., edge computing device or the like) that has a backhaul connection to the mobile network platform. UAVs may, additionally, or alternatively, communicate data (e.g., control data, user data, etc.) via the wireless tethering or wired link.

In various embodiments, the system 200 includes integrated networks 210 having terrestrial networks and non-terrestrial networks (NTN) as depicted in FIG. 2A. By way of example, the terrestrial networks includes passive optical networks (PON) 206, cellular networks 208, Wi-Fi networks 209, etc. The NTN includes satellite networks 204 by way of example.

In various embodiments, the PON 206 includes architecture having an Optical Line Terminal (PON OLT) optical transceiver at a service provider's central office (CO), connected via optical fiber to a remote node containing a passive optical splitter located in the vicinity (neighborhood) of multiple customers. The fiber may then be connected to an Optical Network Terminal (ONT) as depicted in FIG. 2A. ONTs interface optical signals to electrical signals, such as an Unshielded Twisted Pair (UTP) in a telecommunications network, an example of which is a Digital Subscriber Line (DSL) including its variants, or a coaxial cable in a cable network. As such, the electrical signals can then be sent to the appropriate Customer Premises (CP). Alternatively, optical signals can be sent directly from the remote node containing the passive optical splitter via optical fiber to a Customer Premises/Optical Network Terminal (CP/ONT). The ONT in this context is an addressable device that recognizes and accepts only downstream data addressed specifically to it. The PON architecture can further provide trunking to another type of network element, such as a Digital Subscriber Line Access Multiplexer (DSLAM). In this network architecture, the fiber connects via a Gigabit Interface Converter (GBIC) to DSLAM which provides optical/electrical signal interface and multiplexing functionality, and makes the connection to the appropriate DSL modem at Customer Premises (CP).

All networks, including PONs comprising network devices such as ONTs, require a level of network monitoring and management to facilitate efficient, effective and reliable operation. A Network Management System (NMS) typically employs a combination of hardware and software to monitor and administer a network.

As described above, the architecture of the PON 206 include physical channels and distribution mechanisms corresponding to a receiving unit (RU) and a distributed unit (DU) under the O-RAN standard. As depicted in FIG. 2A, the PON nodes (PON OLT/ONT) are communicatively connected to a Service Management and Orchestration (SMO) platform 220 of the O-RAN 201 (particularly, O1 termination 208) via O1 interface. The O1 interface is a logical connection between all O-RAN managed elements and management entities within the SMO 220. Via the O1 interface, O-RAN components such as a radio unit (RU), a distribution unit (DU), a control unit (CU), etc. are managed by the SMO. With respect to the PON 206, the SMO 220 is enabled to do management functions, such as provisioning management services, fault supervision management services, performance assurance management services, file management services, communication surveillance, startup and registration management services for physical network functions (PNFs), etc. The O-RAN architecture allows the collection, access to and management of data records relating to the traffic transferred over the PON OLT, the selected routing and the handover operations carried out. For this purpose, the data is transmitted between the PON networks 206 and the SMO 220 via the O1 interface.

In various embodiments, the PON 206 is O-RAN based optical networks supporting artificial intelligence/machine learning (AI/ML) approaches, and the O1 interface is used to collect/training data that can be used for ML purposes from the DU and CU of the PON networks 206 such as PON OLT and PON ONTs. The O1 interface between the SMO 220 and the PON 206 is an extension of the O1 interface under the O-RAN standard, which is directed to a connection between cellular networks and the SMO.

In various embodiments, the cellular network 208 includes the O-RAN as an access network. The access network of the cellular network 208 uses Radio Resource Control (RRC) protocol and includes other components such as a Media Access Control (MAC) function and a physical layer (PHY). Functions of the RRC protocol include connection establishment and release functions, broadcast of system information, radio bearer establishment, reconfiguration and release, paging notification and release, etc. By signaling functions, the RRC configures user and control planes according to the network status and allows for radio resource management strategies to be implemented. The O-RAN 201 as depicted in FIG. 2A serves to provide the functions of the access network for the cellular network 208.

In exemplary embodiments, the access network of the cellular networks 208 may be implemented in open source software (e.g., in an OpenAirInterface (OAI) wireless technology platform). The access network may include network resources, such as one or more physical access resources and/or one or more virtual access resources. Physical access resources can include base station(s) (e.g., one or more eNodeBs, one or more gNodeBs, or the like, such as base stations), one or more satellites, one or more Gigabyte Passive Optical Networks (GPONs) or related components (e.g., Optical Line Terminal(s) (OLT), Optical Network Unit(s) (ONU), etc.), and/or the like. A base station may employ any suitable radio access technology (RAT), such as 4G/LTE, 5G, 6G, or any higher generation RAT. One or more edge computing devices (e.g., multi-access edge computing (MEC) devices or the like) may also be included in or associated with the access network 204. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the access network may include any number/types of physical/virtual access resources and various types of heterogeneous cell configurations with various quantities of cells and/or types of cells.

As described above, the O-RAN 201 for the cellular networks 208 include the structures that correspond to a radio unit (RU) and a distributed unit of the O-RAN standard as the access network. As depicted in FIG. 2A, RAN nodes are communicatively connected to the SMO 220 (i.e., the O1 termination 228) via the O1 interface. Via the O1 interface, the SMO 220 is enabled to do management functions, such as provisioning management services, fault supervision management services, performance assurance management services, file management services, communication surveillance, startup and registration management services for physical network functions (PNFs), etc. with respect to the cellular networks 208. The SMO 220 is allowed to perform the collection, access to and management of data records relating to the traffic transferred over the RAN, the selected routing and the handover operations carried out. For this purpose, the data is transmitted via the O1 interface.

In various embodiments, the cellular networks 208 are O-RAN based cellular networks supporting AI/ML approaches, and the O1 interface is used to collect/training data that can be used for ML purposes from the DU and CU of the cellular networks 208 such as RAN nodes. In some embodiments, a ML-based non-real time RAN intelligent controller located in the SMO 220 can offer policies to be considered in cell-level optimization by providing (time-varying) optimal configuration sets for cell parameters via the O1 interface.

In various embodiments, the Wi-Fi network 209 may operate in accordance with one or more Institute of Electrical and Electronic Engineers (“IEEE”) 802.11 standards such as IEEE 802.11a, 802.11b, 802.11g, 802.11n, and/or future 802.11 standard. The Wi-Fi network 209 can include one or more access points that provide a radio/air interface over which user equipment can send and/or receive data. In some implementations, user equipment is configured to connect to the Wi-Fi network 209 via one or more secure connections, each of which may utilize an encryption technology such as, WI-FI Protected Access (“WPA”), WPA2, Wired Equivalent Privacy (“WEP”), and/or the like.

In some embodiments, the Wi-Fi network 209 is owned and/or operated by a mobile telecommunications carrier, which may be the same mobile telecommunications carrier that owns and/or operates the mobile telecommunications network. The mobile telecommunications carrier may partner with one or more businesses and/or other entities to provide one or more WI-FI access points in locations used to facilitate access to the WI-FI network by user equipment, such as mobile devices. In some other embodiments, the WI-FI network 209 is a WI-FI network operated by or for a business or other entity (e.g., a municipality) without the involvement of a mobile telecommunications carrier. In some other embodiments, the WI-FI network 209 can be a user WI-FI network. For example, the WI-FI network 209 may be a WI-FI network 209 setup using one or more WI-FI routers in a home, workplace, or other location of a user of the mobile device.

The Wi-Fi networks 209 include physical channels and distribution mechanisms corresponding to a receiving unit (RU) and a distributed unit (DU) under the O-RAN standard. As depicted in FIG. 2A, Wi-Fi access points or controllers are communicatively connected to the SMO platform 220 of the O-RAN 201 (particularly, O1 termination 208) via the O1 interface. With respect to the Wi-Fi networks 209, the SMO 220 is enabled to do management functions, such as provisioning management services, fault supervision management services, performance assurance management services, file management services, communication surveillance, startup and registration management services for physical network functions (PNFs), etc. In some embodiments, O-RAN based Wi-Fi networks may support AI/ML approaches, and the O1 interface is used to collect/training data that can be used for ML purposes from the DU and CU of the Wi-Fi networks 209 such as Wi-Fi access points or controllers. The O1 interface between the SMO 220 and the Wi-Fi networks 209 is an extension of the O1 interface under the O-RAN standard, which is directed to a connection between cellular networks and the SMO.

In various embodiments, the satellite communications network 204 enables user equipment to communicate with a non-terrestrial relay (e.g., a satellite), which communicates signals to terrestrial networks via satellite band signal receiver and associated equipment. Satellite communication systems use radio frequency (RF) signals to send information between distant points on the ground using satellites orbiting the planet. The system has two main parts: a terrestrial segment and a non-terrestrial segment. The terrestrial segment includes fixed or mobile equipment for transmission, reception, and other purposes. The non-terrestrial segment is mainly the satellite itself. Accordingly, the Satellite networks 204 include the structures that correspond to a radio unit (RU) and a distributed unit of the O-RAN standard.

As depicted in FIG. 2A, the satellite networks 204 are communicatively connected to the SMO platform 220 of the O-RAN 201 (particularly, O1 termination 208) via the O1 interface. With respect to the satellite networks 204, the SMO 220 is enabled to do management functions, such as provisioning management services, fault supervision management services, performance assurance management services, file management services, communication surveillance, startup and registration management services for physical network functions (PNFs), etc. In some embodiments, O-RAN based satellite networks may support AI/ML approaches, and the O1 interface is used to collect/training data that can be used for ML purposes from the DU and CU of the satellite networks 204 such as the satellite. The O1 interface between the SMO 220 and the satellite networks 204 is an extension of the O1 interface under the O-RAN standard, which is directed to a connection between cellular networks and the SMO.

In various embodiments, Software-defined RAN (SD-RAN) is 3GPP compliant software-defined RAN that is consistent with the O-RAN architecture. The SD-RAN configurations include a near real-time RAN intelligent controller (near RT-RIC) 212. The near RT-RIC 212 is connected to a central unit control (CU-C) and a central unit user (CU-U) via E2 interface. As depicted in FIG. 2A, the near RT-RIC 212 is connected to each control unit (CU) of the terrestrial networks and the NTN 204, 206, 208 and 209 via an E2 interface. The E2 interface supports network functions that allow southbound nodes to set up the E2 interface and register a list of applications that the southbound nodes support. The E2 interface further allows xApps running in the near-RT RIC to subscribe for events from the southbound nodes, such as prescribing an action to execute upon encountering an event where the action can be to report the event, report, and wait for further control instructions from xApps, or executing a policy. By way of example, the E2 interface supports and facilitates traffic steering, QoS-based resource optimization, massive MIMO optimization, RAN analytics information exposure, general reporting, etc. with respect to cellular networks.

By using the cellular networks 208 as one example, the central unit control (CU-C) and the central unit user (CU-U) are connected to a mobile core. The central unit control plane (CU-C) and the central unit user plane (CU-U) are connected to a distributed unit (DU) which is in turn connected to a radio unit (RU). The RU is in communication with various types of user equipment (UEs) 202, including 4G/5G UEs and wearable devices which include IoT devices.

In other terrestrial and NTN such as the satellite 204, the PON 206, Wi-Fi 209, each network 204, 206 and 209 has a respective RU, CU and DU which correspond to the O-RAN standard, which is in communication with the SMO 220 and the non-RT RIC 218 and the near RT-RIC 212. The RU, CU and DU of each network 204, 206 and 209 are described to the extent that is related to the system 200 and the architecture available in the pertinent technical field can be utilized to the extent that is relevant and as needed.

In various embodiments, the E2 interface of the O-RAN 201 is extended to include and facilitate the E2 interface between the satellite networks 204 and the near-RT RIC 212, the E2 interface between the PON nodes (OLT/ONT) 206 and the near-RT RIC 212, and the E2 interface between the Wi-Fi networks 209, in addition to the E2 interface between the cellular networks 208 and the near-RT RIC 212.

In various embodiments, the near-RT RIC 212 is a suite of software applications to enable software-defined network functionalities in O-RAN networks. The near-RT RIC 212 handles and manages all RAN operation and optimization procedure such as radio connection management, mobility management, Quality of Service (QOS) management, edge services, radio resource management, policy optimization in RAN, etc. The near-RT RIC 212 also handles per-UE controller load balancing and resource block management and allows for on-boarding of third party control applications as depicted in FIG. 2A (i.e., xApps). Furthermore, the near-RT RIC 212 manages a database (i.e., Network Information Base (NIB)) which captures the near real-time state of the underlying network. The near-RT RIC 212 also defines the extended E2 interface between the near-RT RIC 212 and the terrestrial networks and the NTN 204, 206, 208, 209, etc., as described above.

As depicted in FIG. 2A, the near-RT RIC 212 is connected, via an interface A1, to the Service Management and Orchestration (SMO) platform 220 according to the O-RAN standard. The SMO platform 220 is an automation platform for O-RAN and includes a non-real-time radio intelligent controller (Non-RT RIC) 218. The Non-RT RIC 218 handles service and policy management and operates with the near RT-RIC 212 to execute real-time control functions via the interface A1. Network management applications in the Non-RT RIC 218 receive highly reliable data over the O1 interface. As depicted in FIG. 2A, the O1 interfaces are present between the satellite networks 204 and the SMO 220, between the PON nodes (OLT/ONT) 206 and the SMO 220, and between the Wi-Fi access points or controllers 209 and the SMO 220. In some embodiments, network operators deploy core algorithm of the Non-RT-RIC 218 in order to modify the RAN behaviors.

In various embodiments, the near-RT RIC 212 supports an xApp which is an application that needs to execute at timescales of less than a second. Applications that need to execute at timescales of greater than a second are referred to as rApps and the non-RT RIC 218 uses rApps to analyze various information and generate policies. The near-RT RIC 212 handles xApps, such as Mobility Management, and the non-RT RIC 218 handles the high-level orchestration functions and provides policies to the near-RT RIC 212 over the A1 interface.

As to the cellular networks 208, a CU of the O-RAN can be collocated with a User Plane Function (UPF) and a Multi-Edge Computing (MEC) platform 216 and application at an edge site. This configuration allows a local breakout of user traffic at a distributed edge site that is close to the user equipment, thereby facilitating a low-latency service access. This configuration further allows user traffic to be handled locally at the edge site without forwarding user traffic to a backhaul network. When a CU, UPF, and MEC are collocated together, on the same network functions virtualization infrastructure (NFVI) layer, the MEC platform and applications can use a network quality status for the Radio Network Information Service (RNIS) through API exchange within the platform.

In various embodiments, as depicted in FIG. 2A, a CU of the Satellite network 204, a CU of the PON 206, and a CU of the Wi-Fi system 209 can be collocated with the MEC platform 216. The near-RT RIC 212 maintains the Network Information Base (NIB) 215 which captures the near real-time state of the underlying network and includes a data structure that performs network management.

In various embodiments, the Service Management and Orchestration (SMO) platform 220 may reside in a regional cloud. The Service Management and Orchestration (SMO) platform 220 is connected to and communicate with the integrated network 210 via the O1 interface. The SMO framework 220 includes a plurality of rApps 221, 222 and 223. The rApps 221, 222 and 223 utilize artificial intelligence (AI) or trained machine learning (ML) techniques 224 on cloud to perform analytics. For instance, reported or discovered transmission delays or packet loss, network congestion, network availability information, etc. can be analyzed by using the AI/ML techniques 224. The rApps 221, 222 and 223 periodically poll the AI/ML models 224 to check congestion, communication failure, etc. in the network and determine a need to switch to another network.

In various embodiments, the near-RT RIC 212 includes a new version of an xApp, an xI-ANR application 214. The xI-ANR application 214 corresponds an integrated xApp relating to Automatic Neighbor Relation (ANR). The integrated xApp accommodates both terrestrial and NTN. The xI-ANR application 214 is configured to perform ANR operations and add and/or remove neighbors. A Neighbor Relation Table 217 is coupled to the xI-ANR application 214 to access data stored in the Table 217 and add/remove neighbors to/from the table 217.

ANR operations are one of features introduced in Self-Organizing Networks (SON) and automatically generate neighbor relations between base station cells. The neighbor relations are used to establish connections to based station cells to support mobility, load balancing, dual connectivity, etc. In cellular networks such as 5G NR networks, ANR functions reside in a gNodeB and manages a neighbor relation table (NRT). A neighbor detection function finds new neighbors and adds them to the NRT or removes outdated neighbor(s) from the NRT. In the 5G NR networks, a gNodeB controlling a source ell keeps the NRT containing NR-Cell Global Identifier (NCGI) and Physical Cell Identity (PCI) of a target cell.

Manually provisioning and managing neighbor cells in a traditional mobile network can be a challenging task and it becomes more difficult as new mobile technologies are being rolled out. For LTE, task becomes challenging for operators, as in addition of defining intra LTE neighbor relations for eNodeBs (eNBs), operators should provision neighboring 2G, 3G, CDMA2000 cells as well.

An existing Neighbor cell Relation (NR) from a source cell to a target cell means that an eNB controlling the source cell knows the ECGI/CGI and Physical Cell Identifier (PCI) of the target cell and has an entry in the NRT for the source cell identifying the target cell. For each cell that the eNB has, the eNB keeps a NRT. For each NR, the NRT contains the Target Cell Identifier (TCI), which identifies the target cell. For E-UTRAN, the TCI corresponds to the E-UTAN Cell Global Identifier (ECGI) and Physical Cell Identifier (PCI) of the target cell. The ANR function relies on cells broadcasting their identity on global level, ECGI and allows Operation & Management module (O&M) to manage the NRT. The O&M system can add and delete NRs and also change the attributes of the NRT. The O&M system is informed about changes in the NRT.

As depicted in FIG. 2A, new rApps in the SMO platform 220 include: rI-ANR 221, rRecovery 223, and rI-STM 222. The term, “rI,” indicates an integrated rApp that accommodates terrestrial and NTN systems. Accordingly, the rI-ANR indicates the integrated rApp relating to Automatic Neighbor Relation, rRecovery indicates an rApp relating to recovery, and rI-STM indicates the integrated rAPP relating to Service aware integrated terrestrial and NTN traffic management. The rApps are contained in the Non-RT RIC 218.

In various embodiments, the rI-ANR application 221 subscribes service from service exposure for policies related to neighbor relationships and service from Inter-SMO 226 related to adding new NTN neighbors from other SMO such as SMO2 230 as depicted in FIG. 2A. The rRecovery application 223 subscribes service from Network Function-Operations and Maintenance (NF-OAM) 227 in SMO 220 related to fault of network. The rRecovery application 223 makes decisions regarding recovery, including adding new NTN (inter/intro-SMO) to assist recovery. The rI-STM application 222 performs service aware integrated terrestrial and NTN traffic management. For instance, the rI-STM application 222 is configured to manage how traffic should be assigned to which technologies, depending on application, network load conditions, performance, etc.

In various embodiments, as depicted in FIG. 2A, the new xApps in near-RT: RIC xI-ANR 214 takes input from the rI-ANR 221 related to adding new neighbors via A1 interface. The rApp, XI-ANR 214 implements improved ANR for integrated terrestrial and NTN systems and can add or remove neighbors.

In various embodiments, the system 200 is configured to provide extended micro-services in O-RAN architecture. In order to enable integrated terrestrial and NTN systems, the system 200 is configured to include corresponding micro-services. The micro-services include new rApps in the SMO 220, such as the rI-ANR 221, which subscribes the service from Service exposure for policies related to neighbor relationships, subscribes the service from Inter-SMO 226 related to adding new NTN neighbors from other SMO such as the SMO2 230, rRecovery 223 which subscribes the service from NF-OAM function in SMO related to fault of network, makes decision regarding recovery, including adding new NTN (inter/intro-SMO) to assist recovery, and rI-STM 222 which facilitates service aware integrated terrestrial and NTN traffic management. For the integrated and extended services covering the terrestrial and NTN systems, the xI-ANR 214 is also configured in the system 200 by taking input from rI-ANR 221 related to adding new neighbors via the A1 interface.

In various embodiments, the system 200 is configured to extend O-RAN interfaces to facilitate inter-SMO communication between different SMOs (can be from same or different service providers). The information exchange between the SMOs can include requests adding one or more NTN systems from a peer SMO as new neighbor(s), informing to remove NTN neighbor(s) from the peer SMO. Inter-Carrier (inter-operator) communication can be used for the NTN system usage and neighbor addition. As depicted in FIG. 2A, another SMO, SMO2 230 is in communication with the SMO1 220. The SMO2 230 is connected to a satellite 231 which is a NTN system. The SMO1 220 and the SMO2 230 are in communication via the Inter-SMO module 226 and 233 and the satellite 231, which is controlled by the SMO2 230, can be added to the NRT 217 and removed later depending on whether there is a need to be connected to the satellite 231.

In various embodiments, the system 200 implements extensions of interfaces of the O-RAN architecture. By way of example, the system 200 is configured to provide extensions of the O1 interface for SMOs 220, 230 to have a big picture and knowledge about network condition across terrestrial and NTN networks (e.g. network failure, load). As described above, the O1 interface is extended to include the O1 interface between satellite 204 and SMO1 220, the O1 interface between PON nodes (OLT/ONT) 206 and the SMO1, the O1 interface between Wi-Fi AP or controller 209 and SMO1 220. As another example, the system 200 is further configured to provide extensions of E2 interface for UE measurements (including adding new neighbor) and network condition across terrestrial and NTN networks: (the E2 interface is between the NT RIC 212 and wireless/NTN nodes), E2 interface between the satellite 204 and near-RT RIC 212, and the E2 interface between PON nodes (OLT/ONT) 206 and near-RT RIC 212, and the E2 interface between WiFi or WiFi controller 209 and the near-RT RIC 212. As described above, the rApps 221, 222, 223 and xApps 214 are configured to enable integrated ANR and Service aware traffic management.

FIG. 2B depicts non-limiting embodiments of operations of the system 200 enabling integration of terrestrial and NTN systems. In various embodiments, SMO1 220 has service subscription that facilitates services for integrated terrestrial and NTN systems. In various embodiments, the rApp, rI-ANR 221 subscribes the service (Flow 242) from Service exposure related to neighbor relation policies (Flow 241). The rApp, rRecovery 223 subscribes NF-OAM services from the NF OAM 226 (Flow 243). The rApp, rI-ANR 221 subscribes the service from Inter-SMO 227 for potential addition from one or more inter-carrier NTN systems such as the SMO2 230 (Flow 251). The rApp, rI-ANR 221 subscribes the service from the rApp, rRecovery 223 in case of service recovery (Flow 245).

In various embodiments, the UE 202 transmits a measurement report to the integrated networks of terrestrial and NTN systems 210 (Flow 246), which then forwards the measurement report to the xApp, xI-ANR 214 (Flows 247 and 248). The xApp, xI-ANR 214 may trigger a neighbor to be added in the ANR Table 217 (Flow 249). The ANR Table 217 is configured for normal ANR operations and extended to include NTN system. By way of example, the UE 202 is a mobile device and sends the measurement report to its serving cell. The xApp, xI-ANR 214 receives the measurement report and the ANR Table 217 is modified to add neighbor information, which can be another base station or a satellite network.

FIG. 2C depicts a non-limiting embodiment of an ANT table which is configured to integrate terrestrial and NTN systems. Specifically, FIG. 2C depicts integrated ANR information managed and configured by the xApp, xI-ANR 221. In various embodiments, to enable integrated terrestrial and NTN systems, the ANR Table 217 is configured to add “Access Type” to indicate which type of access technologies, such as 5G, 6G, satellite, . . . , etc. Additionally, the ANR Table 217 is further configured to add “Sub-type” field in relationship to the access type (e.g. mmW, low-band, mid-band, . . . LEO for satellite) in the ANR Table 217. As depicted in FIG. 2C, the Access Type in the ANR Table 217 includes terrestrial networks and NTN. The ANR Table 217 further includes a Carrier field to indicate it is an inter or an intra carrier system. Additional information IEs can be exchanged from access nodes to the near-RT RIC 212 via E2, which trigger the addition to the integrated ANR table 217. The enhanced ANR Table 217 can also be implemented at each access node, and on PON 206 and the WiFi system 209.

Referring back to FIG. 2B, by way of example, RAN reports failure to NF-OAM 226 via O1 alarm (Flow 250). The rApp, rRecovery 223 have already subscribed the service from NF-OAM 226 in the SMO1 220 related to fault of network and therefore, receives a fault notification (Flow 250). The rApp, rRecovery 223 makes a decision regarding recovery, including adding a new NTN as one example. The new NTN can belong to an inter-SMO (e.g., the SMO2 230) or an intra SMO (e.g., the SMO1 220).

In various embodiments, the rApp, rRecovery 223 requests Inter-SMO function 223 to request temporary usage of NTNs from inter-carrier SMO2 230 (Flow 251). Inter-SMO communication (Flow 251) is related to adding new NTN neighbors from SMO2 230. Upon approval, SMO1 220 notifies the rApp, rI-ANR 221 for the list of NTN systems (under SMO2 230) that can be added to the system (Flows 251, 252). The rApp, rI-ANR 221 also receives a request from rRecovery 223 regarding which network elements/NTN system can be added to the network (Flow 245). The rApp, rI-ANR 221 informs the xApp, the xI-ANR 214 in the near-RT RIC 212 via A1 interface to add a list of new neighbors including NTN systems (Flow 252). The rApp, rI-ANR 221 commands the xApp, the xI-ANR 214 to add the corresponding new neighbor to the integrated ANR Table 217 (Flows 249, 252). The rApp, rI-STM 222 configures the access system with service aware integrated terrestrial and NTN traffic management (Flow 253).

As described in the embodiments above, the intelligent integrated terrestrial networks (wireline, cellular, Wi-Fi, etc.) with NTN systems facilitate application aware NTN vs. terrestrial network selection and provide increased capacity, coverage, and improved resiliency. Improved O-RAN interfaces, including the O1 and E2 interfaces, the new rApps in SMO, such as rI-ANR, rRecovery, and rI-STM, and new xApps in near-RT-RIC, such as xI-ANR, enable service aware integrated networks. Improved ANR for integrated terrestrial and NTN systems inter-carrier (inter-operator) communication for NTN system usage can be especially beneficial for disaster or network outage situation.

As described in the embodiments above, based on the UE measurement report, the subscription to service exposure, the network conditions, applications running on the UE, etc., received from the integrated networks via the O1 interface and the E2 interface, the SMO 220 of the O-RAN determines selecting a non-terrestrial network over a terrestrial network or vice versa, determines whether network resources by an intra- are sufficient and available or whether network resources by an inter-SMO carrier should be used, etc. The SMO 220 of the O-RAN further determine whether to add neighbor network(s) in light of the network capacity, bandwidth requirements, quality of service requirements associated with applications, quality of experience, etc. For instance, if applications running on the UE require low latency and the network capacity is fully utilized, the SMO 220 of the O-RAN determine whether to switch to a non-terrestrial network such as a satellite to ensure low latency service requirements. If all satellite resources run by the SMO 220 are at capacity, then the SMO 220 communicates the neighbor SMO 230 to check the satellite 231 managed by the neighbor SMO 230 via the inter-SMO 226 as shown in FIG. 2A. If the satellite 231 is available and use of the satellite 231 is approved by the SMO 230, then the SMO 220 notifies the rApp, rI-ANR 221 of a list of new neighbors including the satellite 231 which in turn notifies the xI-ANR 214. The xI-ANR 214 updates the ANR table 217 to include the satellite 231 as shown in FIG. 2C.

In various embodiments, the PON networks 206 can be selected when secured communications are service requirements and wireless resources are at capacity or experiencing delays. The Wi-Fi networks 209 can be used to back up the cellular networks 208 when the wireless resources are at capacity and applications do not require large bandwidth or communication resources. Accordingly, the integrated networks 210 can be fully utilized in the service aware manner, terrestrial networks and non-terrestrial networks selectively used, and each network in the terrestrial networks and each network in the non-terrestrial networks can be used to accommodate the network conditions, the UE measurements, the subscribed services, or a combination thereof.

FIG. 2D depicts an illustrative embodiment of a method 260 in accordance with various aspects described herein. The method 260 further includes communicating with integrated networks including one or more terrestrial networks and one or more non-terrestrial networks, wherein user equipment (UE) are connected to the integrated networks for communication (Step 262); running a non-real time radio access network intelligent controller (non-RT RIC) at a service management and orchestration platform (SMO) (Step 264); running a near-real time radio access network intelligent controller (near-RT RIC), wherein the near-RT RIC is in communication with the non-RT RIC (Step 266); receiving network conditions and UE measurements across the integrated networks (Step 267); subscribing services from service exposure for policies (Step 268); and based on the received network conditions, the UE measurements, or both and based on the services subscription, selecting a network among the integrated networks (Step 269).

In various embodiments, the running the non-RT RIC further includes running a first rApp configured to manage integrated automatic neighbor relation (ANR) information relating to the UE, wherein the integrated ANR information covers terrestrial networks and non-terrestrial networks; and receiving a request to add a new neighbor network, wherein the new neighbor network includes a non-terrestrial network. The running the near-RT RIC further comprises running an xApp in communication with the first rApp. The method 260 further comprise using the first rApp, commanding the xApp to add the new neighbor network to an automatic neighbor relation (ANR) table. The method 260 further include executing a second rApp configured to determine a presence or absence of a recovery need; receiving the UE measurement at the second rApp; upon the determination of the presence of the recovery need based on the UE measurement, determining to add the new neighbor network including the non-terrestrial network; and sending the request to add the new neighbor network to the first rApp.

In various embodiments, the method 260 further comprise executing a third rApp to configure the O-RAN with a service aware data traffic management. The method 260 further comprise, using the first rApp and the second rApp, performing an inter-service management and orchestration (SMO) communication with another SMO platform supporting an additional terrestrial network, an additional non-terrestrial network, or both. The communicating with integrated networks further comprises extending an O1 interface between a service management and orchestration (SMO) platform of the O-RAN and the integrated networks to include the O1 interface between the SMO platform and the one or more non-terrestrial networks. The method 260 further includes applying a machine learning model to execution of the first rApp, the second rApp, the third rApp or a combination thereof.

FIG. 2E depicts an illustrative embodiment of a method 270 in accordance with various aspects described herein. The method 270 includes connecting a user equipment (UE) to integrated networks including one or more terrestrial networks and one or more non-terrestrial networks (Step 272), running a non-real time radio access network intelligent controller (non-RT RIC) at a service management and orchestration platform (SMO) of the O-RAN by running a plurality of rApps to manage traffic from the one or more terrestrial networks and the one or more non-terrestrial networks (Step 274), and running a near-real time radio access network intelligent controller (near-RT RIC), wherein the running the near-RT RIC further comprises running an xApp to receive a UE measurement report and manage an automatic neighbor relation table in response to a command from one or more of the plurality of rApps (Step 276).

In various embodiments, the running the plurality of rApps further comprises running a first rApp to subscribe services from service exposure related to neighbor related policies, subscribe services from inter-SMO related to potential addition from inter-carrier non-terrestrial networks, and subscribe services from a recovery rApp of the plurality of rApps. The running the plurality of rApps to manage traffic further includes running the second rApp configured to detect and manage recovery events involving both the one or more terrestrial networks and the one or more non-terrestrial networks. The running the plurality of rApps further comprises running a third rApp to configure the O-RAN with service aware network management traffic management.

In various embodiments, the method 270 further comprise facilitating a communication between the first rApp and the xApp to request the xApp to modify neighbor information in the automatic neighbor relation table. The running the second rApp further comprise: detecting a presence or absence of a recovery need; and upon the detection of the presence of the recovery need, determining to add a new neighbor network, wherein the new neighbor network includes one of a terrestrial network and a non-terrestrial network by either an intra-SMO carrier or an intra-SMO carrier.

FIG. 2F depicts an illustrative embodiment of a method 280 in accordance with various aspects described herein. The method 280 includes connecting, by a processing system of an open radio access network (O-RAN) including a processor, a user equipment to integrated networks including one or more terrestrial networks and one or more non-terrestrial networks (Step 282), receiving network conditions and UE measurements across the integrated networks (Step 283); executing, by the processing system, a non-real time radio access network intelligent controller (non-RT RIC) at a service management and orchestration (SMO) platform of the O-RAN, wherein the executing the non-RT RIC comprises running a plurality of rApps configured to manage traffic from the one or more terrestrial networks and the one or more non-terrestrial networks (Step 284); executing, by the processing system, a near-real time radio access network intelligent controller (near RT RIC), wherein executing the near RT RIC further comprises running an xApp configured to manage an automatic neighbor relation table in response to a command by one or more of the plurality of rApps (Step 285); subscribing services from service exposure for policies (Step 286); based on the received network conditions, the UE measurements, or both and based on the services subscription, selecting a network among the integrated networks or adding a new neighbor network (Step 287); and configuring, by the processing system, the O-RAN with service aware integrated terrestrial and NTN traffic management (Step 288).

In various embodiments, the running the plurality of rApps further includes: running a first rApp configured to manage automatic neighbor relation of both the one or more terrestrial networks and the one or more non-terrestrial networks; running a second rApp configured to detect and manage recovery events involving both the one or more terrestrial networks and the one or more non-terrestrial networks; and executing a third rApp to configure the O-RAN with a service aware data traffic management. The method 280 further comprise facilitating, by the processing system, a communication between the first rApp and the xApp to request the xApp to modify neighbor information in the automatic neighbor relation table. The method 280 further includes configuring, by the processing system, to extend an O1 interface and an E2 interface to facilitate non-terrestrial networks in addition to terrestrial networks and facilitate other terrestrial networks in addition to cellular networks.

In various embodiments, the running the second rApp further comprise detecting, by the processing system, a presence or absence of a recovery need; and upon the detection of the presence of the recovery need, determining, by the processing system, to add new neighbor networks including non-terrestrial networks from an inter-SMO carrier. The method 280 further includes, upon receiving approval from the inter-SMO carrier, notifying, by the processing system, the first rApp of a list of the non-terrestrial networks from the inter-SMO carrier, and informing, by the processing system, the xApp of the list of new neighbor networks including the non-terrestrial networks from the inter-SMO carrier.

While for purposes of simplicity of explanation, the respective processes are shown and described as a series of blocks in FIGS. 2D through 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

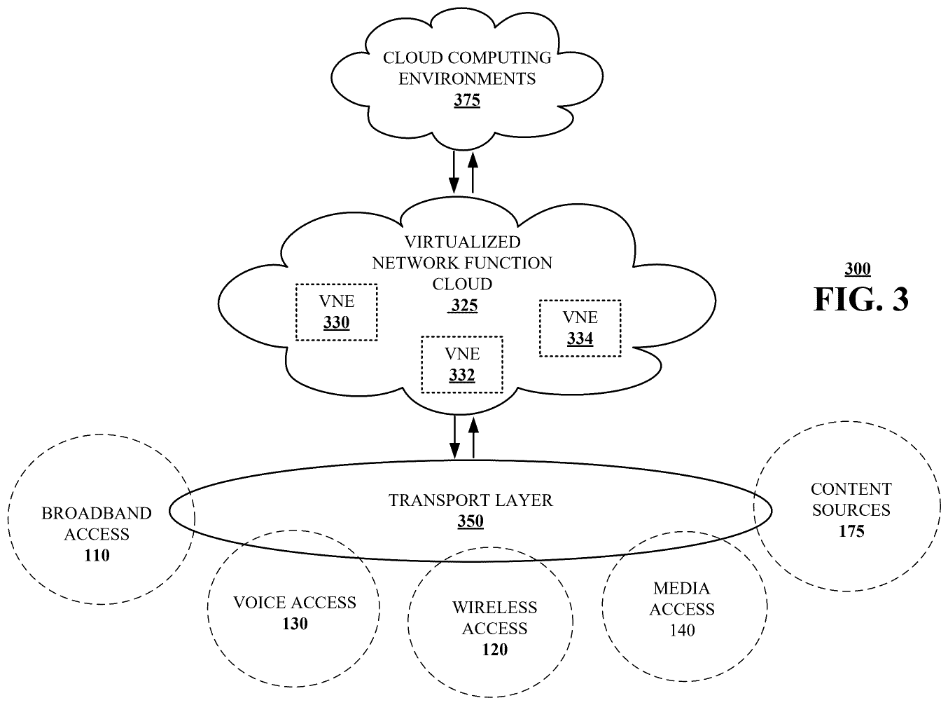

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and methods 260, 270, 280 presented in FIGS. 1, 2A, 2B, 2C, 2D, 2E, 2F and 3. For example, virtualized communication network 300 can facilitate in whole or in part systems and methods for implementing service aware integrated terrestrial networks (TN) and non-terrestrial networks (NTN).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

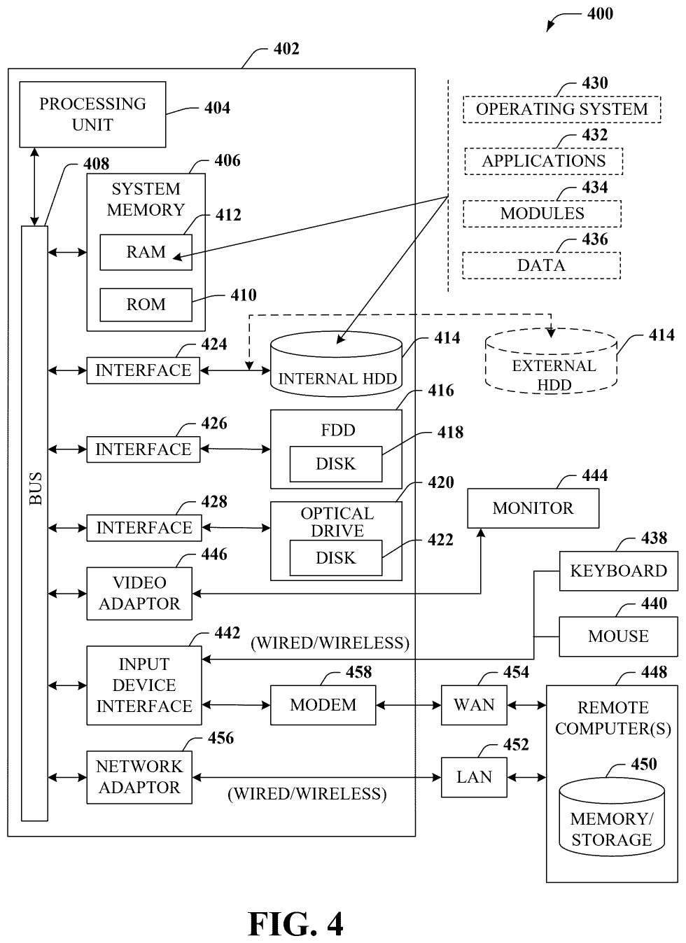

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods for implementing service aware integrated terrestrial networks (TN) and non-terrestrial networks (NTN).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

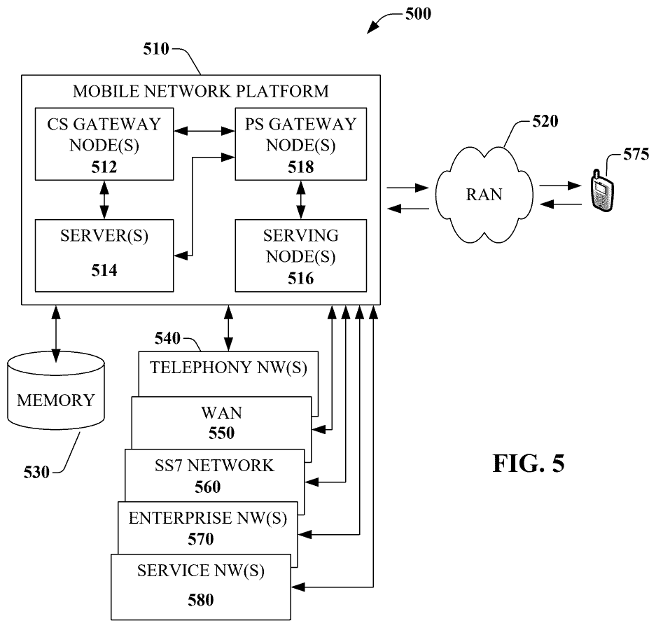

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods for implementing service aware integrated terrestrial networks (TN) and non-terrestrial networks (NTN). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

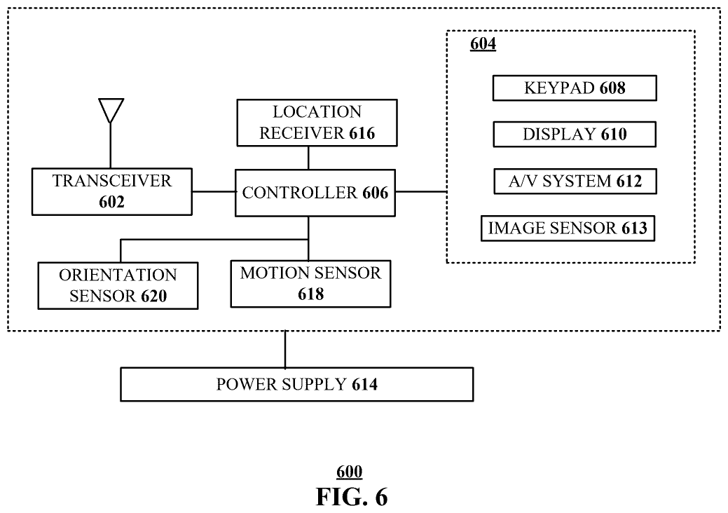

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods for implementing service aware integrated terrestrial networks (TN) and non-terrestrial networks (NTN).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system of an open radio access network (O-RAN) including a processor; and
a memory that stores executable instructions that, when executed by the processing system, facilitate performance of operations, the operations comprising:
communicating with integrated networks including one or more terrestrial networks and one or more non-terrestrial networks, wherein user equipment (UE) are connected to the integrated networks for communication;
running a non-real time radio access network intelligent controller (non-RT RIC) at a service management and orchestration platform (SMO) of the O-RAN;
running a near-real time radio access network intelligent controller (near-RT RIC), wherein the near-RT RIC is in communication with the non-RT RIC;
receiving network conditions and UE measurements across the integrated networks;
subscribing services from service exposure for policies; and
based on the received network conditions, the UE measurements, or both and based on the services subscription, selecting a network among the integrated networks.

2. The device of claim 1, wherein the running the non-RT RIC further comprises:
running a first rApp configured to manage integrated automatic neighbor relation (ANR) information relating to the UE, wherein the integrated ANR information covers terrestrial networks and non-terrestrial networks; and
receiving a request to add a new neighbor network, wherein the new neighbor network includes a non-terrestrial network.

3. The device of claim 2, wherein the running the near-RT RIC further comprises running an xApp in communication with the first rApp;
wherein the operations further comprise using the first rApp, commanding the xApp to add the new neighbor network to an automatic neighbor relation (ANR) table.

4. The device of claim 2, wherein the operations further comprise:
executing a second rApp configured to determine a presence or absence of a recovery need;
receiving the UE measurement at the second rApp;
upon the determination of the presence of the recovery need based on the UE measurement, determining to add the new neighbor network including the non-terrestrial network; and
sending the request to add the new neighbor network to the first rApp.

5. The device of claim 4, wherein the operations further comprise:
executing a third rApp to configure the O-RAN to provide a service aware data traffic management.

6. The device of claim 4, wherein the operations further comprise, using the first rApp and the second rApp, performing an inter-service management and orchestration (SMO) communication with another SMO platform supporting an additional terrestrial network, an additional non-terrestrial network, or both.

7. The device of claim 1, wherein the communicating with integrated networks further comprises extending an O1 interface between a service management and orchestration (SMO) platform of the O-RAN and the integrated networks to include the O1 interface between the SMO platform and the one or more non-terrestrial networks.

8. The device of claim 5, wherein the operations further comprise applying a machine learning model to execution of the first rApp, the second rApp, the third rApp or a combination thereof.

9. A non-transitory machine-readable medium, comprising executable instructions that, when executed by a processing system of an open radio access network (O-RAN) including a processor, facilitate performance of operations, the operations comprising:
connecting a user equipment (UE) to integrated networks including one or more terrestrial networks and one or more non-terrestrial networks:
running a non-real time radio access network intelligent controller (non-RT RIC) at a service management and orchestration platform (SMO) of the O-RAN by running a plurality of rApps to manage traffic from the one or more terrestrial networks and the one or more non-terrestrial networks; and
running a near-real time radio access network intelligent controller (near-RT RIC), wherein the running the near-RT RIC further comprises running an xApp to receive a UE measurement report and manage an automatic neighbor relation table in response to a command from one or more of the plurality of rApps.

10. The non-transitory machine-readable medium of claim 9, wherein the running the plurality of rApps further comprises running a first rApp to:
subscribe services from service exposure related to neighbor related policies;
subscribe services from inter-SMO related to potential addition from inter-carrier non-terrestrial networks; and
subscribe services from a recovery rApp of the plurality of rApps.

11. The non-transitory machine-readable medium of claim 10, wherein the running the plurality of rApps to manage traffic further comprises:
running a second rApp configured to detect and manage recovery events involving both the one or more terrestrial networks and the one or more non-terrestrial networks.

12. The non-transitory machine-readable medium of claim 11, wherein the running the plurality of rApps further comprises:
running a third rApp to configure the O-RAN with service aware network management traffic management.

13. The non-transitory machine-readable medium of claim 10, wherein the operations further comprise facilitating a communication between the first rApp and the xApp to request the xApp to modify neighbor information in the automatic neighbor relation table.

14. The non-transitory machine-readable medium of claim 11, wherein the running the second rAPP further comprise:
detecting a presence or absence of a recovery need; and
upon the detection of the presence of the recovery need, determining to add a new neighbor network, wherein the new neighbor network includes one of a terrestrial network and a non-terrestrial network by either an intra-SMO carrier or an intra-SMO carrier.

15. A method, comprising:
connecting, by a processing system of an open radio access network (O-RAN) including a processor, a user equipment to integrated networks including one or more terrestrial networks and one or more non-terrestrial networks:
receiving network conditions and UE measurements across the integrated networks;
executing, by the processing system, a non-real time radio access network intelligent controller (non-RT RIC) at a service management and orchestration (SMO) platform of the O-RAN, wherein the executing the non-RT RIC comprises running a plurality of rApps configured to manage traffic from the one or more terrestrial networks and the one or more non-terrestrial networks;
executing, by the processing system, a near-real time radio access network intelligent controller (near RT RIC), wherein executing the near RT RIC further comprises running an xApp configured to manage an automatic neighbor relation table in response to a command by one or more of the plurality of rApps;
subscribing services from service exposure for policies;
based on the received network conditions, the UE measurements, or both and based on the services subscription, selecting a network among the integrated networks or adding a new neighbor network; and
configuring, by the processing system, the O-RAN with service aware integrated terrestrial and NTN traffic management.

16. The method of claim 15, wherein the running the plurality of rApps further comprises:
running a first rApp configured to manage automatic neighbor relation of both the one or more terrestrial networks and the one or more non-terrestrial networks;
running a second rApp configured to detect and manage recovery events involving both the one or more terrestrial networks and the one or more non-terrestrial networks; and
executing a third rApp to configure the O-RAN with a service aware data traffic management.

17. The method of claim 16, further comprising facilitating, by the processing system, a communication between the first rApp and the xApp to request the xApp to modify neighbor information in the automatic neighbor relation table.

18. The method of claim 16, further comprising:
configuring, by the processing system, to extend an O1 interface and an E2 interface to facilitate the one or more non-terrestrial networks in addition to the one or more terrestrial networks and facilitate other terrestrial networks in addition to cellular networks.

19. The method of claim 16, wherein the running the second rApp further comprise:
detecting, by the processing system, a presence or absence of a recovery need; and
upon the detection of the presence of the recovery need, determining, by the processing system, to add new neighbor networks including non-terrestrial networks from an inter-SMO carrier.

20. The method of claim 19, further comprising:
upon receiving approval from the inter-SMO carrier, notifying, by the processing system, the first rApp of a list of the non-terrestrial networks from the inter-SMO carrier; and
informing, by the processing system, the xApp of the list of new neighbor networks including the non-terrestrial networks from the inter-SMO carrier.
